(19) United States
(12) Patent Application Publication
(10) Pub. No.: US 2008/0301068 A1
(43) Pub. Date: Dec. 4, 2008

(54) Process for logistics management

(75) Inventors: James R. Fager, Sparland, IL (US); Jason A. Deverman, Tremont, IL (US); Patrick D. Bivens, Bartonville, IL (US); Angie L. Russell, Pekin, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/155,197

(22) Filed: May 30, 2008

(30) Foreign Application Priority Data
Jun. 1, 2007 (DE) 10 2007 025 582.0

(51) Int. Cl. G06Q 90/00

(52) U.S. Cl. 705/500

(57) ABSTRACT

A system and method are provided for servicing back orders and replenishing stock in order to provide high service level while preventing overstocking of material. Goods are produced at a first location and a certain number of the goods is required at a second location at a certain time. A number of goods may be required in general, but a smaller number of goods may be urgently needed. The entire delivery may be split between different modes of transport according to a low priority category and a high priority category. The system and method may include a tool to effectively manage when to split replenishment material transfers from the first location to at least one second location into first and second modes of transport. The system and method also may allow transfer orders to cover back order needs at a second location regardless of inventory available at a first location.

### TECHNICAL FIELD

The present disclosure relates generally to logistics, and more particularly, to a process for logistics management involving international logistics.

### BACKGROUND

The present disclosure may find application in providing supply for a production line where parts need to be available at certain times so as to maintain smooth running of the production line. This is important, for example, in modern production where “just-in-time” deliveries are more and more demanded so as to avoid the cost of warehousing while maintaining continuous production. If no parts are available at one time, the entire production process may need to be stopped, resulting in heavy losses.

The present disclosure is directed to a method for servicing back orders and replenishing stock in order to provide a high service level while preventing overstocking of material. This functionality is desired to deliver the necessary number of parts quickly and in an economical fashion. A focus of the disclosure is the ability to split orders among various modes of transport in order to meet delivery time requirements in the most economical way possible under a variety of scenarios.

In logistics, for example in supplying goods, such as parts, including replacement parts, it is important that the transport and storage are organized as economically as possible. Normally, the goods are produced at a first location and a certain number of goods is required at a second location at a certain time. In the global economy, the first location may be on one continent and the second location may be on another continent. If the goods are sufficiently heavy or bulky, transport by sea may then be the most economical option. However, sometimes time is of the essence and smaller amounts of goods may be transported by airplane. This may be the case for perishable goods such as fruits, or for urgent goods such as replacement parts for vehicles, machines, or the like. Of course, the scenario is not limited to transport by air and sea, even though these two may be considered to represent the largest difference and the greatest need for coordination. Other modes of transport could be by road, by rail, etc. The present disclosure may also be applicable even among different kinds of vehicles within each kind of transport, such as air, road, rail, sea, etc.

In case of replacement parts, it may be possible that a number of parts are required in general, for example for replenishing stocks, but a smaller number of parts is urgently needed to fulfill customer orders. Then, one may want to split the entire delivery between different modes of transport. Further, a shipment may be under way via sea transport. This shipment may still take considerable time to reach its destination. In that case, air transport may still bring the goods to the destination at an earlier point in time, even if initiated after the sea transport has left. Therefore, shipments in transit also should be taken into account. On a further scale, there may be shipments originating in more than one location, and destined for more than one destination. This scenario also should be taken into account.

These ideas apply to facilities linked as part of a network. One or more main facilities may serve, e.g., as a main entry point from suppliers, and then material is moved from that main facility, or facilities, to one or more other, secondary facilities. This technology may be more beneficial when the main facility is located in a different country from the secondary facility and transportation times between facilities are long.

For optimized logistics, a balance must be found between economic transport and time constraints. In the past, the process was manually performed using reports. Hence, what is needed is an automated low cost solution for effectively managing logistics, such as aftermarket replacement parts inventory.

### SUMMARY

The present disclosure provides an effective evaluation of material in transit to one or more second locations when evaluating need to ship material via air transportation to fill customer orders that had fallen past due. The present disclosure also provides a tool to effectively manage when to split replenishment material transfers from the first location to the at least one second location into first and second modes of transport. The present disclosure enables a real time customer emergency order response technology.

The present disclosure provides a tool that enables more effective use of inventory when transporting from at least one first location to at least one second location. According to the present disclosure, exemplary embodiments of a system and method are provided for servicing back orders and replenishing stock in order to provide high service level while preventing overstocking of material. The present disclosure enables satisfaction of service targets, and reduces the need for manual review.

### BRIEF DESCRIPTION OF THE DRAWINGS

FIG. 1 is a schematic view showing an environment for application of the present disclosure.

### DETAILED DESCRIPTION

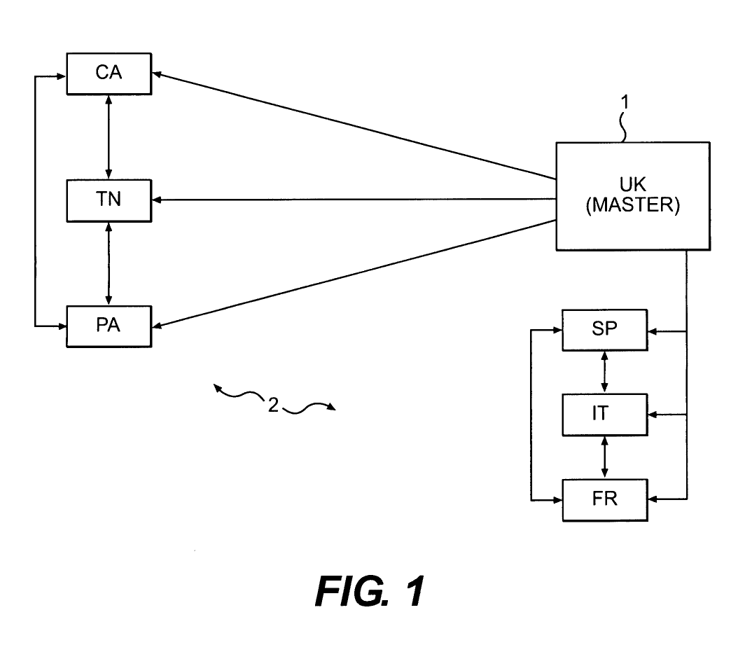

An example for a system in which the present disclosure may find an application is a full replacement parts management system. This system covers warehouse management, customer orders, financial recording of parts business, supply ordering, and Inventory Management (IM) for various facilities. As an illustrative example shown in FIG. 1, an embodiment is explained with regard to a system in which a Master facility 1 is located in the UK, whereas satellites or recipients of goods 2 are located both in Europe and in North America. Referring to FIG. 1, the recipients of goods in North America may include Canada (CA), Tennessee (TN) and Pennsylvania (PA), for example, and the recipients of goods in Europe may include Spain (SP), Italy (IT), and France (FR), for example. The arrows in FIG. 1 illustrate possible transport paths of goods using various modes of transport.

According to an aspect of the present disclosure, transfer orders may be allowed to cover back order needs at a second location (North America) regardless of inventory available at a first location (Master facility). Conventionally, there are two methods by which transfer orders are created to fill back orders at satellite warehouses. These methods are pull deployment and back order referral, also known as hot deployment. Currently, pull deployments will not create a transfer order if there is no inventory at the master facility. Currently, transfer order consolidation for back order referral runs multiple times a day for the first location (UK) and is managed at the corporate level. At this time, consolidation is done every two hours. As hot transfer orders are created for back orders out of the sales order process, a record is written for the transfer order into a work file. When the transaction processes according to set interval, the process reads through the work file and sums up records at the warehouse level or stock keeping unit (SKU) level, i.e., a local level. Thus, only one transfer order is created per item per warehouse. The back order referral process does not consider the inventory position of the first location (master). A transfer order is created for the need regardless of inventory levels.

With the use of alternate sourcing, a back order need in a second location, e.g., a North American warehouse, needs to be filled, whether in real time through the back order referral process or during batch through pull deployment, regardless of the inventory position at the first location, e.g., a facility in the UK. The process will need to run daily and take into consideration back orders which have been alternate sourced during the day. To fulfill this requirement, changes need to be made to pull deployment.

For pull deployment between a first location, such as a master facility in Europe, and a second location, such as a North American warehouse, the requirements would be:
1) If there is a need in a highest priority category (Tier1) for a second location (e.g., a North American warehouse), then create a transfer order regardless of the inventory position at the first location (master).
2) The transfer order to cover the back order must be created with an indicator for modes of transport being set to a fast mode of transport. For example, an air/sea indicator would be set to air.
3) Orders for fast modes of transport (e.g., air orders) should not exceed requirements of a second priority category (Tier2). The balance of the requirements should be sent by slow modes of transport (e.g., by sea). For example, if the total requirement was 20 pieces with 5 pieces coming from each of four possible priority categories (Tier1 to Tier4), then two transfer orders would be created: one transfer order for a quantity of 10 to cover the highest priority category and the second priority category (Tier1 and Tier2) which would be sent by fast modes of transport (e.g., air), and a second transfer order for a quantity of 10 to cover the third and lowest priority categories (Tier3 and Tier4) which would be sent by slow modes of transport (e.g., sea).
4) The logic should be configurable, i.e., not specific to a user. For example, configuration should be possible by region.
5) The back order referral process may need to be modified so that it can be turned on or off depending on the region.

Transfer orders accordingly are created to cover back order needs in a second location (North America) regardless of inventory position at the first location (master). The benefits of this feature are an improved service by covering back orders, e.g., for North American facilities, that have longer lead times.

For the sake of further discussion, air transport is used as an example of a fast mode of transport, whereas sea transport is used as an example of a slow mode of transport. Of course, other configurations and scenarios are conceivable for slow and fast modes of transport, such as regular mail service and courier service, rail transport and air transport, rail transport and road transport, etc. Further, for the sake of illustrating an example, the first location is assumed to be a master or production facility in Europe, e.g., in the UK, and the at least one second location is assumed to be a North American warehouse. Of course, there may be a plurality of second locations such as plural North American warehouses. Further, the present disclosure is applicable to other combinations and functions of first and second locations, e.g., production, import, distribution, etc., within one continent, within one country, or even within one company.

For purposes of this disclosure, the fence date normally is the sum of the time to obtain material for the vendor, i.e., expedite lead time EXPLT, and the transport time for pull deployment by slow modes of transport, i.e., pull days lead time PLDYS. In order to obtain the above and other objects of the present disclosure, it is suggested to modify the fence date logic to include a transfer order quantity already assigned to air that is outside the fence period.

Currently, in deployment the fence date logic accumulates the open transfer order quantity for an item within a time period. The time period is the current date plus the fence date and may also be referred to as the fence window. For fence date logic, the number of fence days can be configured by the system via EXPLT and PLDYS. To get the total number of fence days, these two numbers will be added together. However, the fence days may also be set individually by the user of the system for reasons explained below. The fence days are then added to the current date to establish the fence date. The fence date may be considered the threshold between fast modes of transport (e.g., by air) and slow modes of transport (e.g., by sea). If the transfer order due date is within the fence period, then it is added to the sum. This open transfer order quantity represents the fence quantity, which is the material expected to arrive over the next fence period. In other words, to calculate the fence quantity, all open orders, both fast and slow, that are due within the fence window, are added up. No additional material will be deployed unless the required quantity is above this fence quantity.

According to the present disclosure, it is suggested to modify the logic in deployment to add the total air transfer order quantity outside of the fence period to the open transfer order quantity, both air and sea, within the fence period. This is being done to reduce the number of air orders that are created out of deployment. The reasoning is that if there is an air transfer order that already exists, then it is not possible to get material any quicker and thus there is no need to create another transfer order for the same material. The sum of the air quantity should be all open air orders that are due later than the fence date.

The fence date logic is modified to also include in the fence quantity any air orders that are due outside the fence window. This change was added because even though the order is outside the fence window, it is an emergency and any new transfer order (TO) created could not get there any quicker than emergency (fast method) orders that are already out there.

As an example, the fence days may be set to 2 days. The purpose of the fence days is to set a threshold for the number of days which the user of the system is willing to accept with regard to the risk that an order might not arrive on time. The fence days of 2 days indicates that the user is comfortable assuming that anything due today or in the next two days will indeed arrive at the warehouse. However, this “lead time” is less than the 8 to 10 days that it takes to send material between the UK and US by air transport. This is why all air (fast method) orders are taken into account regardless of fence date. It is accepted that the air orders will arrive on time and thus there is no need to create another order. However, it is not accepted that a sea (slow method) order outside the fence day will arrive on time. Thus, the system is allowed to create an emergency order to fill this requirement.

This explains why there may be air orders outside the fence date. The reason is because the vendor expedite lead time and the pull days lead time are not actually used to set the fence date. The fence date is set based on the amount of risk that the user is willing to assume. For example:
EXPLT days=100
PLDYS days=50
Current Date=2007001
Fence Date=2007151

current date (2007001) plus sum of EXPLT (100) and PLDYS (50)

The fence period would equal January 1st (2007001) through May 30 (2007151)

### Current Transfer Order Data:

Due within fence period
total open qty=100
   open sea qty=80
   open air qty=20

Due after fence date
total open qty=80
   open sea qty=70
   open air qty=10

Under the current calculation, the fence quantity (open transfer order quantity within fence period) would equal 100: the total air quantity (20) and sea quantity (80) due within the fence period. Using the new calculation, the fence quantity would equal 110. The total fence quantity due within the fence period, which is 100, plus the total air quantity due outside the fence period, which is 10, for a total quantity of 110.

In summary, the fence date logic is changed to include all air quantity. In other words, the air quantity, outside of fence period, is added to deployment to reduce the number of air transfer orders created. In this way, the number of emergency/air transfer orders created can be reduced, which in turn reduces cost and prevents overstocking.

According to another aspect of the present disclosure, a regional surplus logic is added to deployment for the second location (North America region). Currently, deployment looks at the inventory needs of each specific warehouse when looking to fill the four priority categories (deployment tiers). Deployment does not look at the inventory available at a regional level.

In order to support the needs of customers, the logic to analyze regional inventory is added to deployment. This is needed to reduce the number of excessive transfer orders created for the North America region when using alternate sourcing. With the use of alternate sourcing, it is not necessary to create a Transfer Order (TO) for a particular warehouse if there is material available elsewhere in the region. As long as the material exists in the region, then the order will be filled through alternate sourcing so a deployment is not necessary.

The regional surplus logic is as follows. If the region has enough inventory to cover the total maximum of the region plus 2 months of regional demand, then there is no need to create a TO for a specific warehouse. It should be noted that, even though no transfer order is created, it is necessary to subtract the quantity from the regional available quantity because it is not desired to deploy material that is expected to be used to fill alternate sourcing. In the case of decimals, any decimals should be rounded up at the warehouse level before calculating regional inventory levels. Also, the regional surplus logic should only be used for tiers 2 (customer specific requirements), 3 (safety stock requirements), and 4 (fair share). For example:

### North American Market:

Ontario, Calif. (CA), Memphis, Tenn. (TN), and York, Pa. (PA) (i.e., a plurality of second locations)

| | CA | TN | PA |
|---|---|---|---|
| outfid1 | 2 | 2 | 5 |
| outfid2 | 1 | 1 | 4 |
| pass-avail | 100 | 0 | 0 |
| pass-dl | 5 | 5 | 7 |
| pass-ss | 2 | 0 | 2 |
| BO shortage | 0 | 1 | 0 |
| pass-max | 6 | 6 | 10 |

wherein
outfid1—forecasted demand for 1st month
outfid2—forecasted demand for 2nd month
pass-avail—available quantity at the warehouse
pass-dl—Tier 2 requirements to fill requests within lead time for that warehouse
pass-ss—Tier 3 requirements to bring inventory up to safety stock for that warehouse
BO shortage—Tier 1 requirements to fill backorders for that warehouse
pass-max—Inventory maximum for that warehouse; the system should not order or deploy material that would put inventory levels over the maximum.
   It is assumed that the UK, i.e., a first location, has 1000 pieces available.
   *** warehouse analyzed in order of leadtime ***

| | CA | TN | PA | SP | IT | FR |
|---|---|---|---|---|---|---|
| tier1 | 0 | 1 | 0 | — | — | — |

Regional surplus not used in tier1 processing so any back order requirement is filled.

| | CA | TN | PA | SP | IT | FR |
|---|---|---|---|---|---|---|
| tier2 | 0 | 5 | 7 | — | — | — |

CA has no requirements

for TN:
region available=100
regional max=22
2 months regional demand equals
   outfid1 (5+2+2) plus outfid2 (4+1+1) for a total of 15.
Since the available quantity of 100 is enough to cover the region surplus of 37 (max of 22 plus demand of 15), then no transfer order is created.
However, it is necessary to subtract the 5 from the region available quantity. For future calculations, the available quantity is now 95.

for PA:
region available=95 (100 minus earlier need of 5 in TN)
region surplus level still equals 37
Since the available quantity of 95 is greater than 37, then no transfer order is created but the region available quantity is now 88.

European repositories (SP, IT, and FR) are analyzed individually as before.

| | CA | TN | PA | SP | IT | FR |
|---|---|---|---|---|---|---|
| tier 3 | 0 | 0 | 2 | — | — | — |

CA has no requirements

TN has no requirements

for PA:
region available=88
surplus level equals 37
No transfer order is created but the requirement of 2 is subtracted from the region available quantity. The region available quantity is now 86.

European repositories are analyzed individually as before tier4

There will be no changes to the fair share logic.

In summary, it is suggested to analyze regional inventory surplus to reduce number of transfer orders created. For example, the number of transfer orders created for North America region can be reduced to provide better service.

According to another aspect of the present disclosure, a flag may be added to deployment for back orders. In other words, there may be a flag for a transfer order if no inventory is available at the Master. The IM representatives would like to be able to identify when a transfer order is created to cover a North America back order and no inventory was available at the Master.

According to the present disclosure, as has been discussed above, a transfer order is created to cover North America back orders regardless of whether the Master has inventory available. However, no logic exists to indicate that the transfer order was created when the Master did not have inventory.

The IM representatives would like a way to identify transfer orders which were created to cover the situation above, e.g., for analysis and further research. A flag will be added to the TO data file coming out of the deployment driver which will identify if a transfer order was created when the Master did not have adequate inventory available. This flag will subsequently be read during the transfer order creation module and the transfer order will be created with a flag. This flag may be the same as is used for back order referrals, i.e., hot deployments, created against the UK by the European repositories.

IM would like to use the flag for the following reasons:
1. These are considered hot deployments just as back order referrals created for Europe and fill the same business need.
2. Simplicity of IM/client analysis and reporting.
   In order to achieve this goal, a flag is added to indicate that the transfer order was created when inventory was not available at the master, resulting in more accurate analysis and reporting.

According to a further aspect of the present disclosure, the case pack factor (CPF) logic for requirements in the highest priority category (Tier1 Requirements) is changed. Currently, in pull deployment, the logic rounds the deployed number down to the nearest whole package quantity according to the case pack factor (CPF) for a transfer order (TO), thus allowing less material to be deployed from the master to the satellites. In the hot deployment process used by the European satellites, the logic rounds the deployed number up to the nearest whole package quantity according to the CPF factor. This allows the system to deploy more material from the master in order to cover back orders in the network. For example, if the TO quantity was 7 and the CPF for the item was 5, pull deployment would create a TO for 5 pieces whereas hot deployment would create a TO for 10 pieces.

According to the present disclosure, for the highest priority category (tier1 requirements) in pull deployment which is used to fill back orders, the CPF logic is changed to round the TO quantity up to the nearest CPF quantity instead of rounding down. This functionality controls whether transfer orders are created to cover back orders if no material exists at the master. As with the functionality of the current back order flag, this functionality will only apply to requirements of the highest priority (tier1 requirements). This is being done in order to better fill back orders for the North American region.

In summary, in accordance with this aspect of the disclosure, the logic is changed to round the TO quantity up to the next CPF for requirements of the highest priority (tier1 requirements) for increased service.

### Industrial Applicability

The following Table 1 shows some examples, including all of the above discussed modifications:

TABLE 1

| | Master | | BO | Split | | | | | |
|---|---|---|---|---|---|---|---|---|---|
| # | Avail | CPF | Flag | Flag | Tier 1 | Tier 2 | Tier 3 | Tier 4 | Result |
| 1 | N | 5 | Y | Y | 17 | 0 | 0 | 0 | Air TO created for 20 pcs. |
| 2 | Y | 5 | Y | Y | 13 | 0 | 0 | 0 | Air TO created for 15 pcs. |
| 3 | Y | 5 | Y | Y | 13 | 5 | 0 | 0 | Air TO created for 15 pcs. |
| 4 | Y | 5 | Y | Y | 17 | 2 | 0 | 0 | Air TO created for 20 pcs. |
| 5 | Y | 5 | Y | Y | 17 | 2 | 1 | 0 | Air TO created for 20 pcs. |
| 6 | Y | 5 | Y | Y | 17 | 2 | 7 | 0 | 2 orders created: |
| | | | | | | | | | Air TO for 20 pcs. |
| | | | | | | | | | for tiers 1 and 2; |
| | | | | | | | | | Sea TO for 5 pcs. |
| | | | | | | | | | for tiers 3 and 4. |
| 7 | Y | 5 | Y | N | 17 | 2 | 1 | 0 | Air TO created for 20 pcs; |
| | | | | | | | | | Tier 3 req filled by air TO |
| | | | | | | | | | due to rounding up of |
| | | | | | | | | | CPF. |
| 8 | Y | 5 | Y | N | 17 | 5 | 10 | 0 | Air TO created for 30 pcs. |
| 9 | Y | 5 | Y | Y | 17 | 2 | 1 | 0 | Air TO created for 20 pcs. |
| 10 | Y | 5 | Y | Y | 17 | 5 | 10 | 0 | 2 orders created: |
| | | | | | | | | | Air TO for 25 pcs. |
| | | | | | | | | | for tiers 1 and 2; |
| | | | | | | | | | Sea TO for 5 pcs. |
| | | | | | | | | | for tiers 3 and 4. |
| 11 | Y | 5 | Y | Y | 22 | 5 | 5 | 10 | 2 orders created: |
| | | | | | | | | | Air TO for 30 pcs. |
| | | | | | | | | | for tiers 1 and 2; |
| | | | | | | | | | Sea TO for 10 pcs. |
| | | | | | | | | | for tiers 3 and 4. |
| 12 | Y | 5 | Y | N | 22 | 5 | 5 | 10 | Air TO created for 30 pcs; |
| | | | | | | | | | sea TO created for 10 pcs. |
| 13 | N | 5 | N | Y | 17 | 0 | 0 | 0 | No TO created because |
| | | | | | | | | | BO flag is turned OFF. |
| 14 | Y | 5 | N | Y | 13 | 0 | 0 | 0 | Air TO created for 15 pcs. |
| 15 | Y | 5 | N | Y | 13 | 5 | 0 | 0 | Air TO created for 20 pcs. |
| 16 | Y | 5 | N | Y | 17 | 2 | 0 | 0 | Air TO created for 20 pcs. |
| 17 | Y | 5 | N | Y | 17 | 2 | 1 | 0 | Air TO created for 20 pcs; |
| | | | | | | | | | no Sea TO created. |
| 18 | Y | 5 | N | Y | 17 | 5 | 10 | 0 | 2 orders created: |
| | | | | | | | | | Air TO for 25 pcs |
| | | | | | | | | | for tiers 1 and 2; |
| | | | | | | | | | Sea TO for 5 pcs |
| | | | | | | | | | for tiers 3 and 4. |
| 19 | Y | 5 | N | N | 17 | 2 | 1 | 0 | Air TO created for 20 pcs. |
| 20 | Y | 5 | N | N | 17 | 5 | 10 | 0 | Air TO created for 30 pcs. |
| 21 | Y | 5 | N | N | 17 | 2 | 7 | 0 | Air TO created for 25 pcs. |
| 22 | Y | 5 | N | Y | 22 | 5 | 5 | 10 | 2 orders created: |
| | | | | | | | | | Air TO for 30 pcs |
| | | | | | | | | | for tiers 1 and 2; |
| | | | | | | | | | Sea TO for 10 pcs |
| | | | | | | | | | for tiers 3 and 4. |
| 23 | Y | 5 | N | N | 22 | 5 | 5 | 10 | Air TO created for 40 pcs. |

It should be noted that the ability to send tier1 and tier2 requirements by fast method, e.g., air transport, is configurable. Conventionally, tier1 requirements were sent by emergency air transport prior to the split logic change because as soon as it was declared an emergency the entire order was sent emergency, i.e., all tiers would go by air. This could obviously prove to be very expensive. To further explain the effect of the changes, a more detailed before/after view is provided below.

### EXAMPLE 1

Master Avail=100 pcs.
Satellite Warehouse has the following requirements:

| | |
|---|---|
| Tier 1 | 2 pcs. |
| Tier 2 | 0 pcs. |
| Tier 3 | 15 pcs. |
| Tier 4 | 0 pcs. |

Expedite BO flag is set to “YES”
CPF=1

In the old system, one TO would have been created for 17 pcs., and because the expedite BO flag was set to “Yes,” then the entire order of 17 pcs. would have been sent by air. In the new system, because the ability to split orders is introduced, only 2 pcs. (tier1 for backorders) will be sent by air, and the rest will be sent by sea, thereby achieving substantial savings in transport expenses. Since in this example the case pack factor CPF=1, the CPF logic would not affect these orders.

### EXAMPLE 2

Master Avail=100 pcs.
Satellite Warehouse has the following requirements:

| | |
|---|---|
| Tier 1 | 2 pcs. |
| Tier 2 | 0 pcs. |
| Tier 3 | 15 pcs. |
| Tier 4 | 0 pcs. |

Expedite BO flag is set to “YES”
CPF=5

In the old system, one TO would have been created for 17 pcs., and because the expedite BO flag was set to “Yes,” then the entire order of 17 pcs. would have been sent by air. In the new system, because the ability to split orders is introduced and the CPF is rounded up for tier1 and tier2 requirements, two orders will be created. 5 pcs. (tier1 requirements rounded up to CPF of 5) will be sent by air and the rest will be sent by sea, thereby achieving considerable savings in transport expenses. The remaining number is only 10 because when the tier1 requirement is rounded up to 5, then the excess of 3 is subtracted from the remaining requirements. This calculation determines a remaining requirement of 12 pcs. Since for tier3 and tier4 requirements the number is not rounded up for the next CPF of 5, only 10 pcs. will be sent.

It will be apparent to those skilled in the art that various modifications and variations can be made to the disclosed method and system without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A system for servicing back orders and replenishing stock in order to provide high service level while preventing overstocking of material, wherein goods are produced at a first location and a certain number of the goods is required at a second location at a certain time,
wherein a first number of goods is ordered to be delivered within a first period of time, and wherein a second number of goods is ordered to be delivered within a second, shorter period of time,
wherein the entire delivery is split between different modes of transport according to a low priority category and a high priority category,
characterized by:
a tool to effectively manage when to split replenishment material transfers from the first location to at least one second location into first and second modes of transport.

2. The system of claim 1, wherein the first location is in one continent or country, and wherein the at least one second location is in another continent or country.

3. The system of claim 1, wherein the different modes of transport include a slow mode of transport and a fast mode of transport.

4. The system of claim 3, wherein the slow mode of transport is transport by sea, and wherein the fast mode of transport is transport by air.

5. The system of claim 1, wherein the mode of transport includes transport by at least one of air, road, rail, or sea.

6. The system of claim 1, wherein the goods are parts or replacement parts for vehicles or machines.

7. The system of claim 1, wherein the system includes a full replacement parts management system, covering warehouse management, customer orders, financial recording of parts business, supply ordering, and inventory management.

8. The system of claim 1, wherein transfer orders are created according to pull deployment mode or hot deployment mode, wherein in the pull deployment mode, transfer orders are normally not created if there is no inventory at a first location, whereas in the hot deployment mode, transfer orders are created regardless of inventory available at a first location, and wherein the pull deployment mode is modified such that transfer orders are allowed to cover back order needs at a second location regardless of inventory available at a first location.

9. The system of claim 8, wherein orders are categorized into four priority categories, and if there is an order in the highest priority category for a second location, then a transfer order is created regardless of the inventory position at the first location.

10. The system of claim 8, wherein the transfer order is created with an indicator for modes of transport being set to a fast mode of transport.

11. The system of claim 10, wherein transfer orders of the highest and second priority category are allocated to a fast mode of transport, and wherein the balance of transfer orders are allocated to a slow mode of transport.

12. The system of claim 1, wherein the system is adapted to be configured by region, and wherein the system is adapted to be turned on or off depending on the region.

13. The system of claim 1, comprising fence date logic which accumulates an open transfer order quantity for an item within a time period, wherein the fence date logic is modified to include a transfer order quantity already assigned to a fast mode of transport that is outside the fence period.

14. The system of claim 1, wherein there is an inventory of goods and a need for goods at a plurality of second locations in a region, and wherein the need of goods for a particular one of the second locations is coordinated so as to be fulfilled by inventory present at another one of the second locations in the region, and a transfer order from the first location to one of the second locations takes into account any exchange of goods among the second locations via a regional surplus logic.

15. The system of claim 14, wherein, if the region has enough inventory to cover the total maximum of the region plus an estimate of two months of regional demand, then no transfer order is created for a specific second location.

16. The system of claim 14, wherein the regional surplus logic is not used for the highest priority category.

17. The system of claim 1, wherein a flag is added to deployment for orders when a transfer order is created to cover a back order at a second location and no inventory was available at the first location.

18. The system of claim 1, wherein transfer orders are created according to pull deployment mode or hot deployment mode, wherein a case pack factor is rounded to the nearest whole package quantity of the goods, wherein in the pull deployment mode the case pack factor is normally rounded down to the nearest whole package quantity for a transfer order, whereas in the hot deployment mode, the case pack factor is rounded up to the nearest whole package quantity, wherein for the highest priority category in the pull deployment mode, the logic is modified such that the case pack factor is rounded up to the nearest whole package quantity instead of being rounded down.

19. A method for servicing back orders and replenishing stock in order to provide high service level while preventing overstocking of material, wherein goods are produced at a first location and a certain number of the goods is required at least at one second location at a certain time,
wherein a first number of goods is ordered to be delivered within a first period of time, and wherein a second number of goods is ordered to be delivered within a second, shorter period of time,
wherein the entire delivery is split between different modes of transport according to a low priority category and a high priority category, respectively, with transfer orders requesting goods to be transferred from the first location to a second location,
the method including:
allowing transfer orders to cover back order needs at a second location regardless of inventory available at a first location.

20. A method of manufacturing goods using a plurality of parts, wherein the parts are produced at a first location and a certain number of the parts is required at a second location at a certain time for manufacturing of the goods,
wherein a number of parts is required in general, but a smaller number of parts is urgently needed,
wherein the entire delivery is split between different modes of transport according to a low priority category and a high priority category, respectively, with transfer orders requesting goods to be transferred from the first location to a second location,
the method including:
allowing transfer orders to cover back order needs at a second location regardless of inventory available at a first location.
